(19) United States
(12) Patent Application Publication
(10) Pub. No.: US 2026/0259532 A1
(43) Pub. Date: Sep. 3, 2026

(54) CALCULATION DEVICE, CONTROL DEVICE, PROCESSING SYSTEM, SEARCHING METHOD, AND RECORDING MEDIUM

(71) Applicant: NEC Corporation, Minato-ku, Tokyo (JP)

(72) Inventor: Kei TAKAYA, Tokyo (JP)

(73) Assignee: NEC Corporation, Minato-ku, Tokyo (JP)

(21) Appl. No.: 18/994,643

(22) PCT Filed: Sep. 14, 2022
(86) PCT No.: PCT/JP2022/034454

§ 371 Date: Jan. 15, 2025

(51) Int. Cl. G05B 13/04; B25J 9/16

(52) U.S. Cl. CPC G05B 13/041; B25J 9/1602; B25J 9/1697

(57) ABSTRACT

A calculator includes a memory configured to store instructions; and a processor configured to execute the instructions to find a solution while finding a solution candidate for an optimization problem with a constraint condition including a variable. In a case where the constraint condition is not satisfied for the found solution candidate, the processor changes a value of the variable related to the constraint condition stricter than a predetermined constraint condition to a possible value of a random variable or changes the value of the variable related to the constraint condition to any one of possible values of the variable included in a second region that does not share a common region with a first region including the value of the variable related to the constraint condition from a value of the first region. The processor finds a solution candidate again after the value of the variable is changed.

### TECHNICAL FIELD

The present disclosure relates to a calculation device, a control device, a processing system, a searching method, and a recording medium.

### BACKGROUND ART

Robots are used in various fields such as logistics. Some robots may operate autonomously. Patent Document 1 discloses technology related to a device for generating a trajectory plan in which the tip of a robot arm moves from a start point to an end point as the related art.

### PRIOR ART DOCUMENTS

### Patent Document

Patent Document 1: Japanese Unexamined Patent Application, First Publication No. 2021-079482

### SUMMARY

### Technical Problem

Meanwhile, it is necessary to find an appropriate plan for a process so that an appropriate process can be executed in consideration of a control process of moving a physical object with a robot described in Patent Document 1, a heat flow control process of controlling a temperature by turning on or off either heating or cooling, a touring problem with a constraint condition in order to which place to visit at a certain time, and the like. Therefore, there is a need for a technology capable of finding an appropriate plan for a process.

An objective of each example aspect of the present disclosure is to provide a calculation device, a control device, a processing system, a searching method, and a recording medium capable of solving the above problems.

### Solution to Problem

According to an example aspect of the present disclosure for achieving the above-described objective, there is provided a calculation device including: a search means configured to find a solution while finding a solution candidate for an optimization problem with a constraint condition including a variable, wherein, in a case where the constraint condition is not satisfied for the found solution candidate, the search means changes a value of the variable related to the constraint condition stricter than a predetermined constraint condition to a possible value of a random variable or changes the value of the variable related to the constraint condition to any one of possible values of the variable included in a second region that does not share a common region with a first region including the value of the variable related to the constraint condition from the first region, and finds a solution candidate again after the change.

According to another example aspect of the present disclosure for achieving the above-described objective, there is provided a control device for controlling a control target based on the solution found by the above-described calculation device.

According to yet another example aspect of the present disclosure for achieving the above-described objective, there is provided a processing system including: the above-described control device; and a robot that is the control target.

According to yet another example aspect of the present disclosure for achieving the above-described objective, there is provided a searching method including: finding a solution while finding a solution candidate for an optimization problem with a constraint condition including a variable; in a case where the constraint condition is not satisfied for the found solution candidate, changing a value of the variable related to the constraint condition stricter than a predetermined constraint condition to a possible value of a random variable or changing the value of the variable related to the constraint condition to any one of possible values of the variable included in a second region that does not share a common region with a first region including the value of the variable related to the constraint condition from the first region; and finding a solution candidate again after the change.

According to yet another example aspect of the present disclosure for achieving the above-described objective, there is provided a recording medium storing a program for causing a computer to: find a solution while finding a solution candidate for an optimization problem with a constraint condition including a variable; in a case where the constraint condition is not satisfied for the found solution candidate, change a value of the variable related to the constraint condition stricter than a predetermined constraint condition to a possible value of a random variable or change the value of the variable related to the constraint condition to any one of possible values of the variable included in a second region that does not share a common region with a first region including the value of the variable related to the constraint condition from the first region; and find a solution candidate again after the change.

### Advantageous Effects of Invention

According to each example aspect of the present disclosure, an appropriate plan for a process can be found.

### BRIEF DESCRIPTION OF DRAWINGS

FIG. 1 is a diagram showing an example of a configuration of a processing system according to an example embodiment of the present disclosure.

FIG. 2 is a diagram showing an example of a configuration of a calculation device according to the example embodiment of the present disclosure.

FIG. 3 is a diagram showing an example of a configuration of a generation unit according to the example embodiment of the present disclosure.

FIG. 4 is a diagram showing an example of position coordinates of a robot hand and position coordinates of a target object in the example embodiment of the present disclosure.

FIG. 5 is a diagram showing an example of each of steps and a movement path of a target object in the example embodiment of the present disclosure.

FIG. 6 is a first diagram showing an image of a solution found using a gradient descent method in the example embodiment of the present disclosure.

FIG. 7 is a second diagram showing an image of a solution found using a gradient descent method in the example embodiment of the present disclosure.

FIG. 8 is a diagram showing an example of a sequence of plans generated by the generation unit according to the example embodiment of the present disclosure.

FIG. 9 is a diagram showing an example of a configuration of a control device according to the example embodiment of the present disclosure.

FIG. 10 is a diagram showing an example of a planned control signal generated by a control unit according to the example embodiment of the present disclosure.

FIG. 11 is a diagram showing an example of a processing flow of a processing system according to the example embodiment of the present disclosure.

FIG. 12 is a diagram showing an example of a minimum configuration of a calculation device according to the example embodiment of the present disclosure.

FIG. 13 is a diagram showing an example of a processing flow of the calculation device 10 having a minimum configuration according to the example embodiment of the present disclosure.

FIG. 14 is a schematic block diagram showing a configuration of a computer according to at least one example embodiment.

### EXAMPLE EMBODIMENT

Hereinafter, example embodiments will be described with reference to the drawings.

### Example Embodiment

A processing system 1 according to an example embodiment of the present disclosure is a system that can appropriately execute a process by finding an appropriate plan for a process for performing a certain process and executing the process based on the found plan. Examples of the processing system 1 include a robot system, a heat flow control system for controlling a temperature by turning on or off either heating or cooling, a system for finding the order of a tour/visit for a place to be visited at a certain time, and the like. Hereinafter, a specific example will be described under the assumption that the processing system 1 is a robot system that grasps and moves a physical object.

### (Configuration of Processing System)

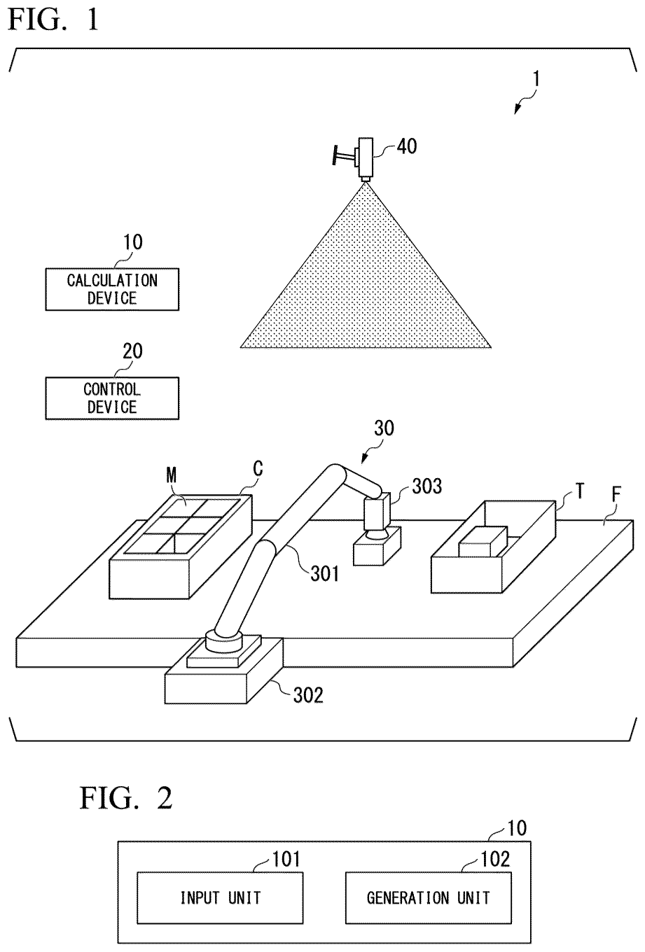

FIG. 1 is a diagram showing an example of a configuration of the processing system 1 according to the example embodiment of the present disclosure. As shown in FIG. 1, the processing system 1 includes a calculation device 10, a control device 20, a robot 30, and an image device 40. In FIG. 1, a floor F, a target object M, a tray T, and a cardboard box C are shown. Hereinafter, the processing system 1 will be described as an example in which the processing system 1 finds a plan for moving the target object M from the tray T to the cardboard box C, and controls the movement of the target object M from the tray T to the cardboard box C based on the found plan.

As shown in FIG. 1, the robot 30 includes a robot arm 301, a pedestal 302, and a robot hand 303. The robot arm 301 is connected to the pedestal 302. The robot hand 303 is connected to an end on an opposite side of an end where the robot arm 301 is connected to the pedestal 302. The robot hand 303 includes, for example, two or more pseudo-fingers or vacuums resembling the fingers of a human or animal. The robot hand 303 grasps the target object M in accordance with a control signal output by the control device 20. The robot arm 301 moves the target object M from a movement source to a movement destination in accordance with the control signal output by the control device 20.

In addition, in each example embodiment of the present disclosure, a “grasp” includes “adsorption” in which the target object M is suctioned by a vacuum or the like and a “pinch” in which a physical object is pinched by two or more pseudo-fingers resembling fingers of a human or animal.

The image device 40 captures a state of the target object M. The image device 40 is, for example, a depth camera, which can identify the state of the target object M (i.e., a position and posture thereof). The image captured by the image device 40 is indicated by, for example, colored point cloud data, and includes three-dimensional information of a captured physical object. The image device 40 outputs a captured image to the generation unit 102.

FIG. 2 is a diagram showing an example of a configuration of the calculation device 10 according to the example embodiment of the present disclosure.

As shown in FIG. 2, the calculation device 10 includes an input unit 101 and a generation unit 102.

The input unit 101 inputs a task goal and constraint conditions to the generation unit 102. Examples of the task goal include information indicating a type of target object M, the number of target objects M to be moved, a movement source of the target object M, and a movement destination of the target object M and the like. Examples of the constraint conditions include an entry prohibition area in a case where the target object M is moved, an area deviating from a movable range of the robot 30, a condition of a face of the target object M related to a grasp of the target object M, release of the grasp of the target object M, or a switching of the target object M from one robot arm to another robot arm, and the like. As a task goal, the input unit 101 may receive, for example, an input “Move three products A from a cardboard box C to a tray T,” from a user, identify that the type of target object M to be moved is products A, the number of target objects M to be moved is three, the movement source of the target object M is the cardboard box C, and the movement destination of the target object M is the tray T, and input identified information to the generation unit 102. Moreover, the position of the target object M identified in the image captured by the image device 40 may be designated as the movement source of the target object M. Moreover, the input unit 101, for example, may receive a position of an obstacle during movement of the target object M from the movement source to the movement destination from the user as a constraint condition indicating the entry prohibition area and input information thereof to the generation unit 102. Moreover, a file indicating a constraint condition is stored in a storage device and the input unit 101 may input the constraint condition indicated in the file to the generation unit 102 and/or the fourth processing unit 102d of the generation unit 102 to be described below may read the constraint condition directly from the file. That is, the acquisition method may be of any type as long as the generation unit 102 can acquire the necessary task goal and the necessary constraint conditions. Details of a method of defining the constraint conditions will be described below.

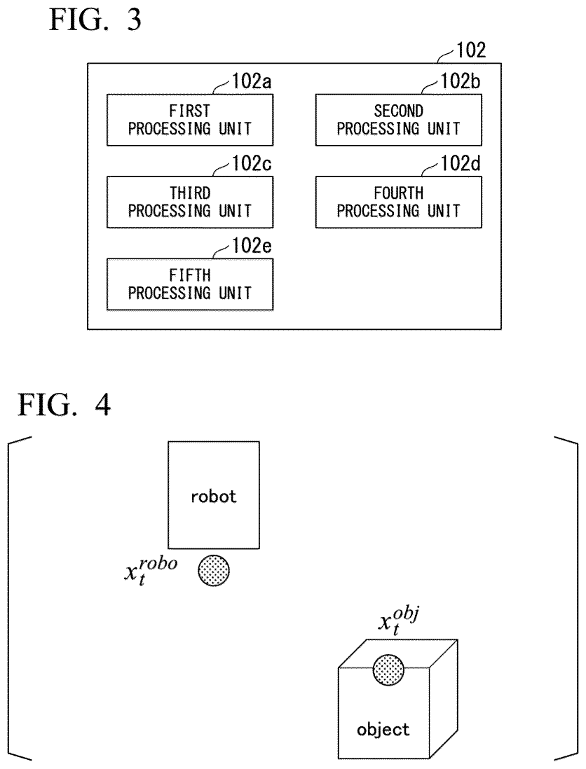

FIG. 3 is a diagram showing an example of a configuration of the generation unit 102 according to the example embodiment of the present disclosure. As shown in FIG. 3, the generation unit 102 includes a first processing unit 102a, a second processing unit 102b, a third processing unit 102c, a fourth processing unit 102d, and a fifth processing unit 102e (an example of a search means and an example of a determination means).

The first processing unit 102a recognizes the robot 30. For example, the first processing unit 102a recognizes a robot model using computer-aided design (CAD) data. The CAD data includes information indicating the shape of the robot 30 and information indicating a movable range such as a reach range of the robot arm 301. The shape includes dimensions. The CAD data is, for example, drawing data designed using CAD.

Moreover, the first processing unit 102a recognizes a surrounding environment of the robot 30. For example, the first processing unit 102a acquires an image captured by the image device 40. The image captured by the image device 40 includes information obtained in a capturing process of the camera and information about a depth direction. This depth direction information corresponds to the colored point cloud data described above. The first processing unit 102a recognizes a position and shape of an obstacle from the image that has been acquired. The obstacle here includes all physical objects other than the target object M to be moved to the movement destination by the robot 30 located within the capturing range of the image device 40. As described above, the image device 40 can acquire three-dimensional information of a physical object within the capturing range. Therefore, the first processing unit 102a can recognize an environment around the robot 30 including the position and shape of the obstacle. In addition, the first processing unit 102a is not limited to a process of recognizing the surrounding environment of the robot 30 from the image captured by the image device 40. For example, the first processing unit 102a may recognize the surrounding environment of the robot 30 using a three-dimensional occupancy map (Octomap), CAD data, augmented reality (AR) markers, and the like. This CAD data includes information indicating the shape of the obstacle. The shape includes dimensions.

Moreover, the first processing unit 102a recognizes a release position at the movement destination of the target object M. For example, in a case where the movement destination is a container (for example, the tray T), the first processing unit 102a recognizes the release position with machine learning using model-based matching. The model-based matching is one of methods of deciding a position and posture of a physical object by performing a comparison process for a shape and structure data with respect to a physical object extracted from the image using image data obtained from the camera or the like and a shape and structure data of a physical object (a container in this case) whose position or posture is desired to be acquired. In addition, the first processing unit 102a is not limited to a processing unit of recognizing the release position by performing machine learning using model-based matching. For example, the first processing unit 102a may recognize the release position using an AR marker.

Moreover, the second processing unit 102b recognizes the pedestal 302 to be described below of the robot 30. For example, the second processing unit 102b recognizes the pedestal 302 by acquiring CAD data. This CAD data includes information indicating the shape of the pedestal 302. The shape includes dimensions. Thereby, the second processing unit 102b can recognize a Z-coordinate of an upper face of the pedestal 302 in a coordinate system as a height of the pedestal 302.

The third processing unit 102c recognizes a state of the target object M (i.e., a position and posture thereof). For example, the third processing unit 102c recognizes the position of the target object M by performing machine learning using model-based matching. Moreover, the third processing unit 102c recognizes the posture of the target object M using technology for generating a bounding box such as an axis aligned bounding box (AABB) or an oriented bounding box (OBB) for the target object M whose position is identified. In addition, the third processing unit 102c may classify the target object M using clustering, which is one of the machine learning methods, and the like with respect to the image captured by the image device 40 and may identify a state of the target object M using technology for generating a bounding box.

Moreover, the third processing unit 102c acquires a height of the target object M. For example, the third processing unit 102c recognizes the target object M by acquiring CAD data. This CAD data includes information indicating the shape of the target object M. The shape includes dimensions. Thereby, the third processing unit 102c can recognize a Z-coordinate of the target object M in a coordinate system as a height of the target object M. In addition, the third processing unit 102c may recognize the height of the target object M by subtracting the Z-coordinate of the pedestal 302 from a Z-coordinate of an upper face of the target object M.

The fourth processing unit 102d acquires various constraint conditions. Also, the fourth processing unit 102d sets the acquired various constraint conditions. Here, details of a method of defining constraint conditions will be described.

FIG. 4 is a diagram showing an example of position coordinates of the robot hand 303 and position coordinates of the target object M in the example embodiment of the present disclosure. First, the position coordinates of the robot hand 303 at time t and the position coordinates of the target object M at time t are defined using the notations in FIG. 4. That is, it is assumed that the position coordinates x(robo, t) of the robot hand 303 at time t are expressed as Expression (1). Moreover, it is assumed that the position coordinates x(obj, t) of the target object M at time t are expressed as Expression (2).

$$\begin{matrix}[ Math . 1 ] & \\ x ( robo , t ) = {x}_{t}^{robo} & ( 1 )\end{matrix}$$

$$\begin{matrix}[ Math . 2 ] & \\ x ( obj , t ) = {x}_{t}^{obj} & ( 2 )\end{matrix}$$

In addition, at time t in a three-dimensional space in which the robot 30 including the robot hand 303 operates and the target object M moves, the position coordinates x(robo, t) indicate a position of the robot hand 303 and the position coordinates x(obj, t) indicates a position of the target object M.

Moreover, a switch variable s(P&P, i, t) represented by Expression (3) is introduced to specify the constraint condition.

$$\begin{matrix}[ Math . 3 ] & \\ s ( P \& P , i , t ) = {s}_{t}^{P \& P , i} & ( 3 )\end{matrix}$$

A case where the switch variable s(P&P, i, t) is 0 indicates that the target object M is not being grasped by the robot hand 303. Moreover, a case where the switch variable s(P&P, i, t) is 1 indicates that the target object M is being grasped by the robot hand 303.

Here, an action plan of the robot in which the robot hand 303 grasps the target object M and moves the target object M at the shortest distance is considered. In this case, a difference between the position of the robot hand 303 at time t and the position of the robot hand 303 at time t+1 (i.e., a movement distance of the robot hand 303 between time t and time t+1) is considered to be the smallest. Therefore, an objective function f can be expressed like Expression (4).

$$\begin{matrix}[ Math . 4 ] & \\ f : = \sum {( {x}_{t + 1}^{r o b o} - {x}_{t}^{robo} )}^{2} & ( 4 )\end{matrix}$$

Moreover, the constraint conditions can be expressed like Expressions (5) to (7).

$$\begin{matrix}[ Math . 5 ] & \\ ( 1 - {S}_{t}^{P \& P , i} ) ( {x}_{t + 1}^{o b j} - {x}_{t}^{o b j} ) = 0 & ( 5 )\end{matrix}$$

$$\begin{matrix}[ Math . 6 ] & \\ {S}_{t}^{P \& P , i} ( {x}_{t}^{o b j} - {x}_{t}^{robo} ) = 0 & ( 6 )\end{matrix}$$

$$\begin{matrix}[ Math . 7 ] & \\ {S}_{t}^{P \& P , i} ( {s}_{t}^{P \& P , i} - 1 ) = 0 & ( 7 )\end{matrix}$$

A first factor on a left side in Expression (5) becomes 0 in a case where the robot hand 303 is grasping the target object M. Moreover, a second factor on the left side in Expression (5) becomes 0 in a case where the position of the target object M at time t and the position of the target object M at time t+1 are the same. Therefore, Expression (5) is a constraint condition that is valid all the time regardless of the position of the target object M (i.e., regardless of whether or not the robot hand 303 is moving) in a case where the robot hand 303 is grasping the target object M. Moreover, Expression (5) is a constraint condition that is valid all the time regardless of whether or not the robot hand 303 is grasping the target object M in a case where the position of the target object M at time t and the position of the target object M at time t+1 are the same (i.e., in a case where the target object M is not moving).

A first factor on the left side in Expression (6) becomes 0 in a case where the robot hand 303 is not grasping the target object M. Moreover, a second factor on the left side in Expression (6) becomes 0 in a case where the position of the target object M at time t and the position of the robot hand 303 at time t are the same. Therefore, Expression (6) is a constraint condition that is valid all the time regardless of whether or not the position of the target object M at time t and the position of the robot hand 303 at time t are the same in a case where the robot hand 303 is not grasping the target object M. Moreover, Expression (6) is a constraint condition that is valid all the time regardless of whether or not the robot hand 303 is grasping the target object M in a case where the position of the target object M at time t and the position of the robot hand 303 at time t are the same.

A first factor on a left side in Expression (7) becomes 0 in a case where the robot hand 303 is not grasping the target object M. Moreover, a second factor on the left side in Expression (7) becomes 0 in a case where the robot hand 303 is grasping the target object M. Therefore, Expression (7) is a constraint condition that is valid all the time either in a case where the robot hand 303 is grasping the target object M or in a case where the robot hand 303 is not grasping the target object M. In addition, because the robot hand 303 is either grasping or not grasping the target object M, the constraint condition according to Expression (7) is provided.

The fourth processing unit 102d sets the constraint conditions as described above. As shown in Expressions (5) to (7), in general, a constraint condition requiring A(x)=0 or B(x)=0 for the variable x can be expressed as A(x)B(x)=0. In a case where constraints other than the above-described constraint conditions are provided, the fourth processing unit 102d may set the constraints by adding further constraint conditions.

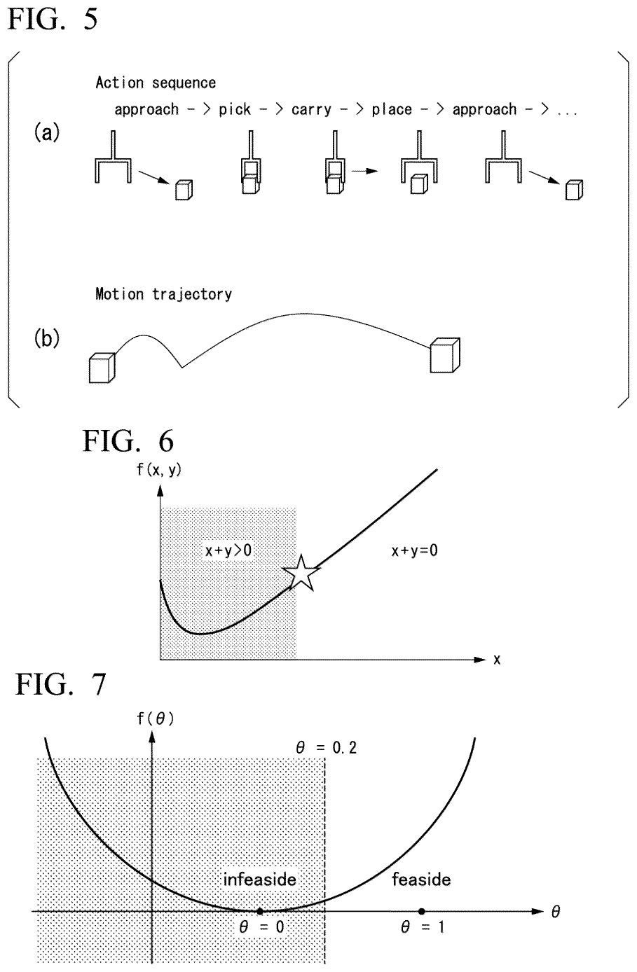

The fifth processing unit 102e generates a sequence indicating a flow of an operation of the robot 30 based on a task goal determined by processes of the first processing unit 102a, the second processing unit 102b, and the third processing unit 102c and constraint conditions set in a process of the fourth processing unit 102d. For example, the fifth processing unit 102e acquires the task goal from the first processing unit 102a, the second processing unit 102b, and the third processing unit 102c. Moreover, the fifth processing unit 102e acquires the constraint conditions from the fourth processing unit 102d. The fifth processing unit 102e adds the constraint conditions acquired from the fourth processing unit 102d to the constraint conditions input from the input unit 101. Also, the fifth processing unit 102e generates information indicating a state of the robot 30 for each time step during the process from a state of the target object M in a movement source to a state of the target object M in a movement destination necessary to generate a control signal for controlling the robot 30 in a control unit 201 to be described below of the control device 20 based on the acquired task goal and constraint conditions (a type of the target object M, a position and posture of the robot 30, the strength of a grasp of the target object M, an operation of the robot 30 (e.g., the operation of the robot 30 including an approach operation for moving toward the target object M (corresponding to the processing of an approach step in FIG. 5 to be described below), a pick operation for grasping the target object M (corresponding to the processing of a pick step in FIG. 5), a carry operation for moving an arm for correctly moving the grasped target object M to a transport destination (corresponding to the processing of a carry step in FIG. 5), or a place operation for releasing the grasp of the target object M (corresponding to the processing of a place step in FIG. 5)), or the like). That is, the information indicating the state of the robot 30 for each time step during the process from the state of the target object M in the movement source to the state of the target object M in the movement destination necessary to generate the control signal for controlling the robot 30 in the control unit 201 to be described below is a sequence.

FIG. 5 is a diagram showing an example of each of steps and a movement path of a target object M in the example embodiment of the present disclosure. The each of the steps and the movement path of the target object M in the sequence for moving the target object M shown in FIG. 5 are found by designating a process of reducing an amount of energy to be consumed by the robot 30 as much as possible, a process of shortening a trajectory along which the robot hand 303 moves as much as possible, a process of shortening a movement path of the target object M as much as possible, or the like as an objective function f in a case where a task goal and various constraint conditions are set and performing simulation in the fifth processing unit 102e. As shown in FIG. 5, examples of the step of moving the target object M from the movement source to the movement destination include an approach step of moving the robot hand 303 toward the target object M, a pick step in which the robot hand 303 grasps the target object M, a carry step in which the robot hand 303 moves the target object M, a place step in which the robot hand 303 releases the grasp of the target object M, and the like.

Here, a method by which the fifth processing unit 102e decides a trajectory along which the robot hand 303 moves at each time step according to simulation will be described. Here, for simplicity, a method of minimizing an objective function f(x, y) in a state in which variables (for example, x and y), which affect the trajectory along which the robot hand 303 moves, are defined and a function f(x, y) indicating the trajectory along which the robot hand 303 moves is designated as an objective function will be described. Moreover, for example, a constraint condition of x+y=0 is set due to a constraint on a movable region of the robot hand 303. In this case, a Lagrangian function L is given as in Expression (8) using a positive constant of λ.

$$\begin{matrix}[ Math . 8 ] & \\ L = f ( x , y ) + {λ ( x + y )}^{2} & ( 8 )\end{matrix}$$

Also, it is only necessary for the fifth processing unit 102e to find a solution using a gradient descent method. Examples of gradient descent methods include a simulated annealing method, a gradient method referred to as a primal-dual interior-point method, and the like. FIG. 6 is a first diagram showing an image of a solution found using a gradient descent method in the example embodiment of the present disclosure. In this case, the fifth processing unit 102e repeatedly searches for a region that satisfies the constraint condition x+y=0 and that has a minimum value by differentiating the Lagrangian function L, thereby identifying a desired solution indicated by a star in FIG. 6 in which the objective function f(x, y) is a minimum. In addition, the Lagrangian function L indicated by Expression (8) is an example and it may be any Lagrangian function generally used in continuous optimization. For example, in a case where an optimization algorithm based on the gradient method referred to as the primal-dual interior-point method is used, the Lagrangian function L is referred to as a barrier function that has a value of zero in the region where the constraint conditions are not violated and takes an infinite value as soon as it enters a region that violates the constraint conditions.

However, in a case where a solution is found by the gradient descent method using the derivative of a function under the certain constraint conditions as described above, there is a possibility that a problem generally called a “non-convex constraint” in which a searchable region for a solution limited by the constraint condition is limited and a minimum value cannot be searched for may occur. That is, in general, in a case where an optimization problem for minimizing (or maximizing) an objective function f is solved using only the gradient descent method, the solution candidate converges to an extreme value without escaping from the extreme value due to the constraint conditions and there is a possibility that a solution for minimizing (or maximizing) the objective function f cannot be found as a result. More specifically, for example, in a case where an optimization problem for minimizing (or maximizing) an objective function f is solved using a simulated annealing method, the temperature is raised to a high temperature, the search range of the solution candidate is expanded (relaxed) and the solution candidate is found within a searchable range while the temperature is gradually lowered. However, in a case where the searchable range is divided while the temperature is gradually lowered, an appropriate solution candidate cannot be found unless an appropriate search range is found before the division. Moreover, in a case where an inappropriate extreme value solution candidate is found using the simulated annealing method, the extreme value solution candidate is found again within the searchable range while the temperature is raised again to a high temperature and the temperature is gradually lowered, and an appropriate solution cannot be found using only the simulated annealing method regardless of how many times the search is iterated in a case where the appropriate search range cannot be found before the division.

In a case where an optimization problem is solved, the fifth processing unit 102e according to the example embodiment of the present disclosure prevents the solution candidate from converging to an extreme value without escaping therefrom, thereby efficiently finding an appropriate solution. Here, a method of preventing the solution candidate from converging to the extreme value without escaping therefrom and efficiently finding an appropriate solution in a case where the fifth processing unit 102e solves an optimization problem will be described. Here, it is assumed that the fifth processing unit 102e finds an extreme value using a gradient descent method. In this regard, a method in which the fifth processing unit 102e efficiently finds an appropriate solution using one variable instead of a plurality of variables will be described here to make the description easier to understand.

Here, a process of minimizing the objective function f(θ) with respect to the objective function f(θ) represented by Expression (9) and the constraint conditions represented by Expression (10) and (11) is considered. That is, a process in which the fifth processing unit 102e minimizes the objective function f(θ) in a case where the Lagrangian function L is represented by Expression (12) is considered. Here, λ and μ are positive constants.

$$\begin{matrix}[ Math . 9 ] & \\ f ( θ ) : = {θ}^{2} & ( 9 )\end{matrix}$$

$$\begin{matrix}[ Math . 10 ] & \\ θ ( 1 - θ ) = 0 & ( 10 )\end{matrix}$$

$$\begin{matrix}[ Math . 11 ] & \\ θ \geq 0.2 & ( 11 )\end{matrix}$$

$$\begin{matrix}[ Math . 12 ] & \\ L = f ( θ ) + {λ ( θ ( 1 — θ ) )}^{2} + {μ ( max ( 0 , \text{-θ} + 0.2 ) )}^{2} & ( 12 )\end{matrix}$$

Here, a function max(a, b) is a function of returning a larger value between the two values a and b.

FIG. 7 is a second diagram showing an image of a solution found using the gradient descent method in the example embodiment of the present disclosure. For example, it is assumed that, for the objective function f and the constraint conditions represented by Expressions (9) to (11), the fifth processing unit 102e searches for a solution θ using the minimum descent method to find the minimum of the objective function f(θ), and the solution candidate converges to the extreme value of θ=0 shown in FIG. 7. In this case, the fifth processing unit 102e cannot find θ=1 that is a correct solution even if it is searched for only by the gradient descent method.

In this way, the solution candidate may converge to an inappropriate extreme value without escaping from the extreme value. Therefore, for example, the fifth processing unit 102e is a search means configured to find a solution while finding a solution candidate for an optimization problem with a constraint condition including a variable. In a case where the constraint condition is not satisfied for the found solution candidate (for example, the inappropriate extreme value), the fifth processing unit 102e changes a value of the variable related to the constraint condition stricter than a predetermined constraint condition to a possible value of a random variable or changes the value of the variable related to the constraint condition to any one of possible values of the variable included in a second region that does not share a common region with a first region including the value of the variable related to the constraint condition from the first region, and finds a solution candidate again after the change. Specifically, the fifth processing unit 102e determines whether or not a constraint condition represented by A(x)B(x)=0 (in the case of the specific example shown herein, a first factor θ on a left side in Expression (10) corresponds to A(x) and a second factor (1−θ) on the left side corresponds to B(x)) is a strong discrete constraint condition in a case where a process based on a first algorithm to be described below is performed. That is, the fifth processing unit 102e sets parameters r, N, M, and K for a constraint condition capable of being expressed as A(x)B(x)=0 in which A(x)=0 or B(x)=0 is required. The parameter r is a parameter for setting a criterion for determining the discrete strength of A(x) in which A(x)=0 and B(x) in which B(x)=0. The parameter r has a value larger than 0 and smaller than or equal to 1. The parameter r indicates that the discreteness of A(x) in which A(x)=0 and B(x) in which B(x)=0 is stronger in a case where the parameter r is closer to 1. The parameter N is a parameter for setting a criterion for a detection ratio of points that do not satisfy A(x)B(x)=0. The parameter M is a parameter for setting the number of iterations of the detection of points that do not satisfy A(x)B(x)=0. The parameter K is a parameter indicating the number of times larger than or equal to the parameter N serving as the reference in a case where the number of iterations of the detection of points that do not satisfy A(x)B(x)=0 is M. An initial value of the parameter K is 0.

The fifth processing unit 102e decides positive values for the parameters r, N, and M. Also, the fifth processing unit 102e samples xA satisfying A(x)=0 and xB satisfying B(x)=0. For example, the fifth processing unit 102e sets a step width α by dividing a line segment between xA and xB that have been sampled into N predetermined equal parts (for example, N=100). The fifth processing unit 102e determines whether or not A(x)B(x)=0 is satisfied every time it is moved from one of xA and xB to the other at an interval of the step width α. In the case of the specific example shown here, θ can only take a value of 0 or 1. Therefore, in the case of the specific example shown herein, the fifth processing unit 102e determines that A(x)B(x)=0 is satisfied for the start point and the end point and A(x)B(x)=0 is not satisfied for other points. The specific example shown here is an example of the most discrete constraint condition in which only the start and end points satisfy A(x)B(x)=0. In a case where it is determined that A(x)B(x)=0 is not satisfied N or more times, the fifth processing unit 102e adds 1 to the value of K. The fifth processing unit 102e performs a process of sampling xA satisfying A(x)=0 and xB satisfying B(x)=0 (M−1) times. Likewise, for each line segment between xA and xB that have been sampled, the fifth processing unit 102e determines whether or not A(x)B(x)=0 is satisfied every time it is moved by the step width α, and finds the cumulative total of K values. Also, the fifth processing unit 102e determines that a constraint condition represented by A(x)B(x)=0 satisfying K/M≥r is a strong discrete constraint condition (an example of a constraint condition stricter than a predetermined constraint condition). Thus, the fifth processing unit 102e determines whether or not the constraint condition represented by A(x)B(x)=0 is a strong discrete constraint condition by performing a process based on a first algorithm.

Moreover, specifically, the fifth processing unit 102e may determine whether or not the constraint condition represented by A(x)B(x)=0 is a strong discrete constraint condition by performing a process based on a second algorithm to be described below. That is, the fifth processing unit 102e sets the parameters N, M, and K for a constraint condition capable of being expressed as A(x)B(x)=0 in which A(x)=0 or B(x)=0 is required. The parameter N is a parameter for setting a criterion for a detection ratio of points that do not satisfy A(x)B(x)=0. The parameter M is a parameter for setting the number of iterations of the detection of points that do not satisfy A(x)B(x)=0. The parameter K is a parameter indicating the number of times larger than or equal to the parameter N serving as the reference in a case where the number of iterations of the detection of points that do not satisfy A(x)B(x)=0 is M. An initial value of the parameter K is 0.

The fifth processing unit 102e decides a positive value for each of the parameters N and M. For example, the fifth processing unit 102e samples xA satisfying A(x)=0 and xB satisfying B(x)=0. Also, the fifth processing unit 102e sets a step width α by dividing a line segment between xA and xB that have been sampled into N predetermined equal parts (for example, N=100). The fifth processing unit 102e determines whether or not A(x)B(x)=0 is satisfied every time it is moved from one of xA and xB to the other at an interval of the step width α. In a case where it is determined that A(x)B(x)=0 is not satisfied N or more times, the fifth processing unit 102e adds 1 to the value of K. The fifth processing unit 102e performs a process of sampling xA satisfying A(x)=0 and xB satisfying B(x)=0 (M−1) times. Likewise, for each line segment between xA and xB that have been sampled, the fifth processing unit 102e determines whether or not A(x)B(x)=0 is satisfied every time it is moved at an interval of the step width α and finds the cumulative total of K values. Also, the fifth processing unit 102e determines that a constraint condition represented by A(x)B(x)=0 satisfying K/M=1 is a strong discrete constraint condition (an example of a constraint condition stricter than a predetermined constraint condition). In the case of the specific example shown here, the fifth processing unit 102e determines that Expression (10) is a strong discrete constraint condition that satisfies K/M=1. Thus, the fifth processing unit 102e may determine whether or not the constraint condition represented by A(x)B(x)=0 is a strong discrete constraint condition by performing a process based on a second algorithm.

Next, the fifth processing unit 102e finds a solution candidate by a gradient descent method. In a case where the solution candidate is found, the fifth processing unit 102e determines whether or not constraint conditions are satisfied for the solution candidate. In a case where it is determined that all the constraint conditions are satisfied for the solution candidate, the fifth processing unit 102e ends the search by designating the solution candidate as a final solution. Also, the fifth processing unit 102e outputs the final solution (i.e., a trajectory along which the robot hand 303 moves at each time step) to the control device 20. Moreover, in a case where it is determined that at least one constraint condition is not satisfied for the solution candidate, the fifth processing unit 102e identifies a variable related to the constraint condition represented by A(x)B(x)=0 determined to be a strong discrete constraint condition. Also, the fifth processing unit 102e changes the value of the identified variable to another possible value of the random variable or changes the value of the identified variable to any one of possible values of the variable included in a second region that does not share a common region with the first region including the value of the variable from the first region.

After the value of the variable is changed, the fifth processing unit 102e finds a solution candidate again by the gradient descent method. The fifth processing unit 102e determines whether or not the constraint conditions are satisfied for the found solution candidate. In a case where it is determined that all the constraint conditions are satisfied for the solution candidate, the fifth processing unit 102e ends the search by designating the solution candidate as a final solution. Also, the fifth processing unit 102e outputs the final solution (i.e., a sequence that is a trajectory along which the robot hand 303 moves at each time step) to the control device 20. Moreover, in a case where it is determined that at least one constraint condition is not satisfied for the solution candidate, the fifth processing unit 102e identifies a variable related to the constraint condition represented by A(x)B(x)=0 determined to be a strong discrete constraint condition. Also, the fifth processing unit 102e changes the value of the identified variable to another possible value of the random variable or changes the value of the identified variable to any one of possible values of the variable included in a second region that does not share a common region with the first region including the value of the variable from the first region.

After the value of the variable is changed, the fifth processing unit 102e finds a solution candidate again by the gradient descent method. The fifth processing unit 102e iterates the determination until it is determined that all the constraint conditions are satisfied for the solution candidate found in the above-described process. The fifth processing unit 102e generates a sequence of plans in this way.

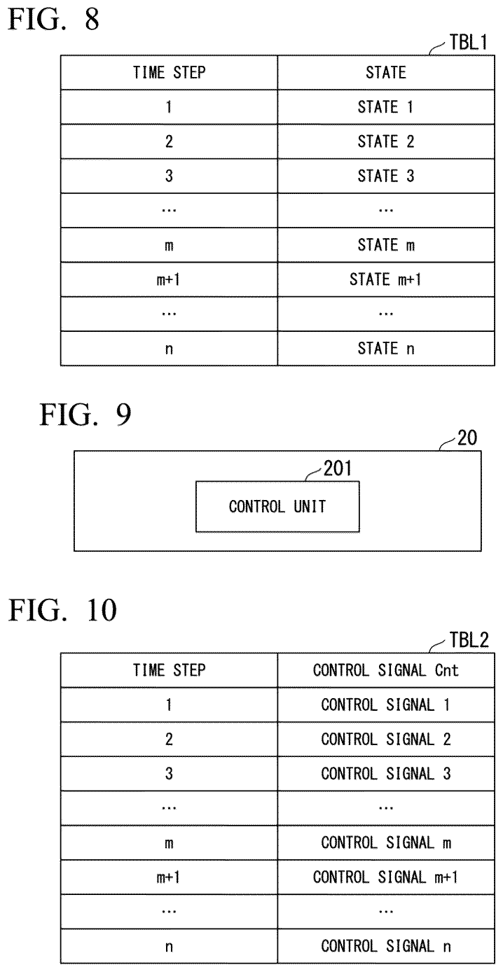

FIG. 8 is a diagram showing an example of a sequence TBL1 of plans generated by the generation unit 102 according to the example embodiment of the present disclosure. For example, as shown in FIG. 8, the sequence TBL1 of plans generated by the generation unit 102 is, for example, a sequence indicating each state of the robot 30 at each time step of n from a movement source to a movement destination of the target object M.

FIG. 9 is a diagram showing an example of a configuration of the control device 20 according to the example embodiment of the present disclosure. The control device 20 includes the control unit 201 as shown in FIG. 9. The control unit 201 generates a control signal for controlling the robot 30 based on the sequence generated by the generation unit 102. That is, a control signal for implementing a posture of the target object M and a movement path of the target object M based on the sequence generated by the calculation device 10 is generated. The control unit 201 outputs the generated control signal to the robot 30.

FIG. 10 is a diagram showing an example of a planned control signal Cnt generated by the control unit 201 according to the example embodiment of the present disclosure. For example, as shown in FIG. 10, the planned control signal Cnt generated by the control unit 201 is each control signal for controlling the robot 30 for each time step of n from the movement source to the movement destination of the target object M.

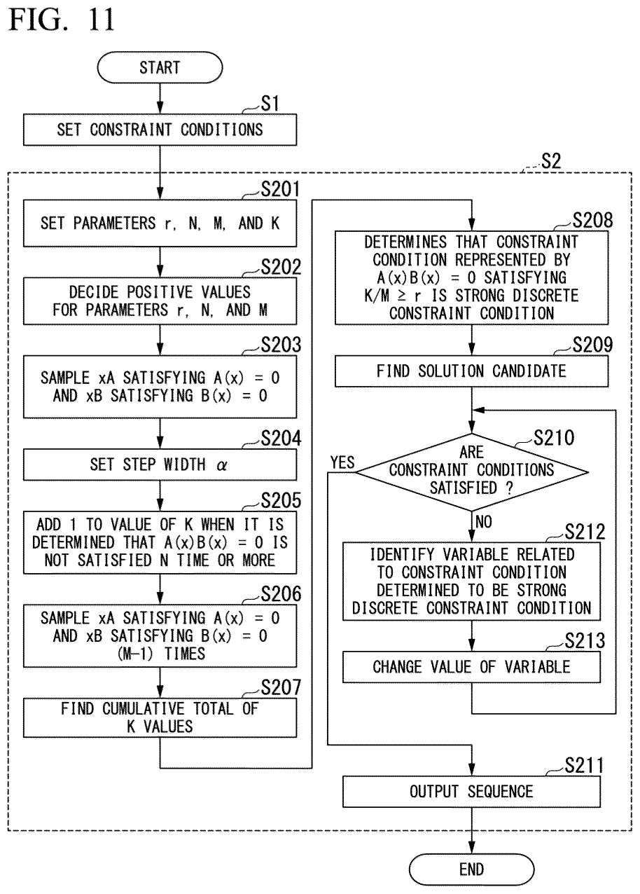

FIG. 11 is a diagram showing an example of a processing flow of the processing system 1 according to the example embodiment of the present disclosure. Here, a sequence performed by the processing system 1 is generated and a process of controlling the robot 30 will be described with reference to FIG. 11. Here, it is assumed that each of the first processing unit 102a, the second processing unit 102b, and the third processing unit 102c performs the above-described process.

The fourth processing unit 102d acquires various constraint conditions. Also, the fourth processing unit 102d sets the various constraint conditions that have been acquired (step S1). For example, the fourth processing unit 102d acquires constraint conditions represented by Expressions (5) to (7). Also, the fourth processing unit 102d sets the constraint conditions represented by Expressions (5) to (7) that have been acquired.

The fifth processing unit 102e generates a sequence indicating the flow of the operation of the robot 30 based on the task goal determined in a process of the first processing unit 102a, the second processing unit 102b, and the third processing unit 102c, and the constraint conditions set in the process of the fourth processing unit 102d (step S2). For example, the fifth processing unit 102e acquires the task goal from the first processing unit 102a, the second processing unit 102b, and the third processing unit 102c. Moreover, the fifth processing unit 102e acquires the constraint conditions from the fourth processing unit 102d. The fifth processing unit 102e adds the constraint conditions acquired from the fourth processing unit 102d to the constraint condition input from the input unit 101. Also, the fifth processing unit 102e generates information indicating a state of the robot 30 for each time step during the process from a state of the target object M in a movement source to a state of the target object M in a movement destination necessary to generate a control signal for controlling the robot 30 in the control unit 201 to be described below of the control device 20 based on the acquired task goal and constraint conditions (a type of the target object M, a position and posture of the robot 30, the strength of a grasp of the target object M, an operation of the robot 30 (e.g., the operation of the robot 30 including an approach operation for moving toward the target object M (corresponding to the processing of an approach step in FIG. 5), a pick operation for grasping the target object M (corresponding to the processing of a pick step in FIG. 5), a carry operation for moving an arm for correctly moving the grasped target object M to a transport destination (corresponding to the processing of a carry step in FIG. 5), or a place operation for releasing the grasp of the target object M (corresponding to the processing of a place step in FIG. 5)), or the like).

For example, the fifth processing unit 102e decides the posture and movement path of the target object M at each time step according to simulation. Specifically, the fifth processing unit 102e sets the parameters r, N, M, and K for a constraint condition that can be represented as A(x)B(x)=0 in which A(x)=0 or B(x)=0 is required (step S201). The fifth processing unit 102e decides a positive value for each of the parameters r, N, and M (step S202). Also, the fifth processing unit 102e samples xA satisfying A(x)=0 and xB satisfying B(x)=0, respectively (step S203). For example, the fifth processing unit 102e sets a step width α by dividing a line segment between xA and xB that have been sampled into N predetermined equal parts (for example, N=100) (step S204). The fifth processing unit 102e determines whether or not A(x)B(x)=0 is satisfied every time it is moved from one of xA and xB to the other at an interval of the step width α. In a case where it is determined that A(x)B(x)=0 is not satisfied N or more times, the fifth processing unit 102e adds 1 to the value of K (step S205). The fifth processing unit 102e performs a process of sampling xA satisfying A(x)=0 and xB satisfying B(x)=0 (M−1) times (step S206). Likewise, for each line segment between xA and xB that have been sampled, the fifth processing unit 102e determines whether or not A(x)B(x)=0 is satisfied every time it is moved at an interval of the step width α, and finds the cumulative total of K values (step S207). Also, the fifth processing unit 102e determines that the constraint condition represented by A(x)B(x)=0 satisfying K/M≥r is a strong discrete constraint condition (step S208). Thus, the fifth processing unit 102e determines whether or not the constraint condition represented by A(x)B(x)=0 is a strong discrete constraint condition by performing a process based on the first algorithm. In addition, a specific example for determining whether or not the constraint condition shown here is a strong discrete constraint condition is based on a process based on the first algorithm described above. However, the process of determining whether or not the constraint condition is a strong discrete constraint condition is not limited to the process based on the first algorithm. For example, the process of determining whether or not the constraint condition is a strong discrete constraint condition may be a process based on the second algorithm described above.

For example, the first factor on the left side in Expression (7) is 0 in a case where the robot hand 303 is not grasping the target object M and the second factor on the left side is 0 in a case where the robot hand 303 is grasping the target object M. That is, there is no region common between A(x) indicated by the first factor on the left side and B(x) indicated by the second factor on the left side. Therefore, the fifth processing unit 102e determines that the constraint condition of Expression (7) is the most discrete constraint condition among the constraint conditions of Expressions (5) to (7).

Next, the fifth processing unit 102e finds a solution candidate by the gradient descent method (step S209). In a case where the solution candidate is found, the fifth processing unit 102e determines whether or not constraint conditions are satisfied for the solution candidate (step S210). In a case where it is determined that all constraint conditions are satisfied for the solution candidate (YES in step S210), the fifth processing unit 102e ends the search by designating the solution candidate as a final solution. The fifth processing unit 102e outputs the final solution (i.e., a sequence that is a trajectory along which the robot hand 303 moves at each time step) to the control device 20 (step S211). Then, the fifth processing unit 102e ends the process.

Moreover, in a case where it is determined that at least one constraint condition is not satisfied for the solution candidate (NO in step S210), the fifth processing unit 102e identifies a variable related to the constraint condition represented by A(x)B(x)=0 determined to be a strong discrete constraint condition (step S212). Also, the fifth processing unit 102e changes the value of the identified variable to another possible value of the random variable or changes the value of the identified variable to any one of possible values of the variable included in a second region that does not share a common region with a first region including the value of the variable from the first region (step S213). For example, in the case of the constraint conditions of Expressions (5) to (7), the fifth processing unit 102e identifies s(P&P, i, t) of Expression (7) as a variable related to the constraint condition determined to be a strong discrete constraint condition. Also, the fifth processing unit 102e changes s(P&P, i, t) from 0 to 1. In addition, because s(P&P, i, t) in Expression (7) shown as an example here can take only 0 or 1, s(P&P, i, t) can only be changed from 0 to 1 or from 1 to 0. The fifth processing unit 102e returns to the processing of step S210.

### Advantage

The processing system 1 according to the example embodiment of the present disclosure has been described above. In the calculation device 10 of the processing system 1, the fifth processing unit 102e (an example of a search means) is a processing unit configured to find a solution while finding a solution candidate for an optimization problem with a constraint condition including a variable. In a case where the constraint condition is not satisfied for the found solution candidate, the fifth processing unit 102e changes a value of the variable related to the constraint condition stricter than a predetermined constraint condition to a possible value of a random variable or changes the value of the variable related to the constraint condition to any one of possible values of the variable included in a second region that does not share a common region with a first region including the value of the variable related to the constraint condition from the first region, and finds a solution candidate again after the change.

In this way, an appropriate plan for a process can be found.

In another example embodiment of the present disclosure, the control device 20 may include the calculation device 10.

In another example embodiment of the present disclosure, the robot 30 may include at least one of the control device 20 and the calculation device 10.

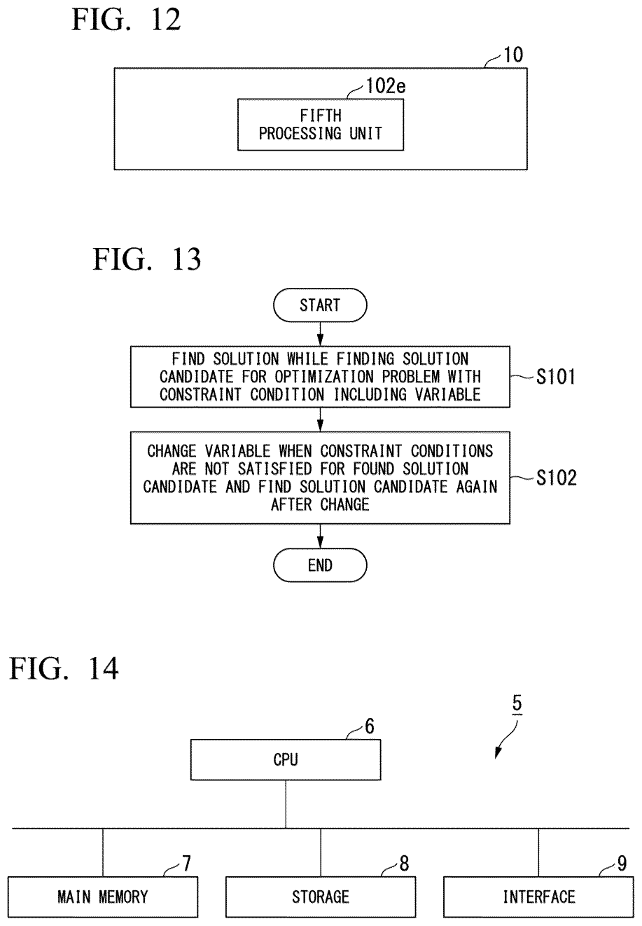

Next, a calculation device 10 having a minimum configuration according to the example embodiment of the present disclosure will be described. FIG. 12 is a diagram showing an example of the minimum configuration of a calculation device 10 according to the example embodiment of the present disclosure. In the calculation device 10 having the minimum configuration according to the example embodiment of the present disclosure, as shown in FIG. 12, the fifth processing unit 102e (an example of a search means) is a processing unit configured to find a solution while finding a solution candidate for an optimization problem with a constraint condition including a variable. In a case where the constraint condition is not satisfied for the found solution candidate, the fifth processing unit 102e changes a value of the variable related to the constraint condition stricter than a predetermined constraint condition to a possible value of a random variable or changes the value of the variable related to the constraint condition to any one of possible values of the variable included in a second region that does not share a common region with the first region including the value of the variable related to the constraint condition from the first region, and finds a solution candidate again after the change. The fifth processing unit 102e can be implemented, for example, using a function provided in the fifth processing unit 102e shown in the example of FIG. 2.

Next, a process of the calculation device 10 having the minimum configuration according to the example embodiment of the present disclosure will be described. FIG. 13 is a diagram showing an example of a processing flow of the calculation device 10 having the minimum configuration according to the example embodiment of the present disclosure. Here, the process of the calculation device 10 having the minimum configuration will be described with reference to FIG. 13.

The fifth processing unit 102e (an example of a search means) finds a solution while finding a solution candidate for an optimization problem with a constraint condition including a variable (step S101). In a case where the constraint condition is not satisfied for the found solution candidate, the fifth processing unit 102e changes a value of the variable related to the constraint condition stricter than a predetermined constraint condition to a possible value of a random variable or changes the value of the variable related to the constraint condition to any one of possible values of the variable included in a second region that does not share a common region with the first region including the value of the variable related to the constraint condition from the first region, and finds a solution candidate again after the change (step S102).

The calculation device 10 having the minimum configuration according to the example embodiment of the present disclosure has been described above. The calculation device 10 can find an appropriate plan for a process.

In the process in the example embodiment of the present disclosure, the order of the processing steps may be changed in a range in which an appropriate process is performed.

Although example embodiments of the present disclosure have been described, the above-described processing system 1, the calculation device 10, the control device 20, the robot 30, the image device 40, and other control devices may have a computer device therein. The process of the above-described processing steps is stored on a computer-readable recording medium in the form of a program, and the above process is performed by the computer reading and executing the program. A specific example of the computer will be described below.

FIG. 14 is a schematic block diagram showing a configuration of a computer according to at least one example embodiment. As shown in FIG. 14, a computer 5 includes a central processing unit (CPU) 6, a main memory 7, a storage 8, and an interface 9. For example, each of the above-described processing system 1, the calculation device 10, the control device 20, the robot 30, the image device 40, and other control devices is installed in the computer 5. Also, the operation of each processing unit described above is stored in the storage 8 in the form of a program. The CPU 6 reads the program from the storage 8, loads the program into the main memory 7, and executes the above-described process in accordance with the program. Moreover, the CPU 6 secures a storage area corresponding to each of the above-described storage units in the main memory 7 in accordance with the program.

Examples of the storage 8 include a hard disk drive (HDD), a solid-state drive (SSD), a magnetic disk, a magneto-optical disk, a compact disc read-only memory (CD-ROM), a digital versatile disc read-only memory (DVD-ROM), a semiconductor memory, and the like. The storage 8 may be an internal medium directly connected to a bus of the computer 5 or an external medium connected to the computer 5 via the interface 9 or a communication line. Also, in a case where the above program is distributed to the computer 5 via a communication line, the computer 5 receiving the distributed program may load the program into the main memory 7 and execute the above process. In at least one example embodiment, the storage 8 is a non-transitory tangible storage medium.

Moreover, the program may be a program for implementing some of the above-mentioned functions. Furthermore, the program may be a file for implementing the above-described function in combination with another program already stored in the computer device a so-called differential file (differential program).

Although several example embodiments of the present disclosure have been described, these example embodiments are examples and do not limit the scope of the present disclosure. In relation to these example embodiments, various additions, omissions, substitutions, and other modifications can be made without departing from the spirit or scope of the present disclosure.

Although some or all of the above-described example embodiments may also be described as in the following supplementary notes, the present disclosure is not limited to the following supplementary notes.
(Supplementary Note 1) A calculation device including:
   a search means configured to find a solution while finding a solution candidate for an optimization problem with a constraint condition including a variable,
   wherein, in a case where the constraint condition is not satisfied for the found solution candidate, the search means changes a value of the variable related to the constraint condition stricter than a predetermined constraint condition to a possible value of a random variable or changes the value of the variable related to the constraint condition to any one of possible values of the variable included in a second region that does not share a common region with a first region including the value of the variable related to the constraint condition from the first region, and finds a solution candidate again after the change.
(Supplementary Note 2) The calculation device according to Supplementary Note 1, wherein, for only a variable contributing to violation of the constraint condition, the search means changes a value of the variable related to the constraint condition to a possible value of a random variable or changes the value of the variable related to the constraint condition to any one of possible values of the variable included in a second region that does not share a common region with the first region including the value of the variable related to the constraint condition from the first region, and finds a solution candidate again after the change.
(Supplementary Note 3) The calculation device according to supplementary note 1 or 2, including a determination means configured to determine whether or not the constraint condition is stricter than the predetermined constraint condition.
(Supplementary Note 4) A control device for controlling a control target based on the solution found by the calculation device according to any one of supplementary notes 1 to 3.
(Supplementary Note 5) A processing system including:
   the control device according to supplementary note 4; and
   a robot that is the control target.
(Supplementary Note 6) A searching method including:
   finding a solution while finding a solution candidate for an optimization problem with a constraint condition including a variable;
   in a case where the constraint condition is not satisfied for the found solution candidate, changing a value of the variable related to the constraint condition stricter than a predetermined constraint condition to a possible value of a random variable or changing the value of the variable related to the constraint condition to any one of possible values of the variable included in a second region that does not share a common region with a first region including the value of the variable related to the constraint condition from the first region; and
   finding a solution candidate again after the change.
(Supplementary Note 7) A recording medium storing a program for causing a computer to:
   find a solution while finding a solution candidate for an optimization problem with a constraint condition including a variable;
   in a case where the constraint condition is not satisfied for the found solution candidate, change a value of the variable related to the constraint condition stricter than a predetermined constraint condition to a possible value of a random variable or change the value of the variable related to the constraint condition to any one of possible values of the variable included in a second region that does not share a common region with a first region including the value of the variable related to the constraint condition from the first region; and
   find a solution candidate again after the change.

### INDUSTRIAL APPLICABILITY

According to each example aspect of the present disclosure, an appropriate plan for a process can be found.

### REFERENCE SIGNS LIST

1 Processing system
5 Computer
6 CPU
7 Main memory
8 Storage
9 Interface
10 Calculation device
20 Control device
30 Robot
40 Image device
101 Input unit
102 Generation unit
102a First processing unit
102b Second processing unit
102c Third processing unit
102d Fourth processing unit
102e Fifth processing unit
201 Control unit
301 Robot arm
302 Pedestal
303 Robot hand
C Cardboard box
F Floor
M Target object
T Tray

What is claimed is:

1. A calculator comprising:
a memory configured to store instructions; and
a processor configured to execute the instructions to:
find a solution while finding a solution candidate for an optimization problem with a constraint condition including a variable,
wherein, in a case where the constraint condition is not satisfied for the found solution candidate, the processor changes a value of the variable related to the constraint condition stricter than a predetermined constraint condition to a possible value of a random variable or changes the value of the variable related to the constraint condition to any one of possible values of the variable included in a second region that does not share a common region with a first region including the value of the variable related to the constraint condition from a value of the first region, and
the processor finds a solution candidate again after the value of the variable is changed.

2. The calculator according to claim 1, wherein, for only a variable contributing to violation of the constraint condition, the processor changes a value of the variable related to the constraint condition to a possible value of a random variable or changes the value of the variable related to the constraint condition to any one of possible values of the variable included in a second region that does not share a common region with the first region including the value of the variable related to the constraint condition from a value of the first region, and
the processor finds a solution candidate again after the value of the variable is changed.

3. The calculator according to claim 1, wherein the processor is configured to determine whether or not the constraint condition is stricter than the predetermined constraint condition.

4. A controller for controlling a control target based on the solution found by the calculator according to claim 1.

5. A processing system comprising:
the controller according to claim 4; and
a robot that is the control target.

6. A searching method comprising:
finding a solution while finding a solution candidate for an optimization problem with a constraint condition including a variable;
in a case where the constraint condition is not satisfied for the found solution candidate, changing a value of the variable related to the constraint condition stricter than a predetermined constraint condition to a possible value of a random variable or changing the value of the variable related to the constraint condition to any one of possible values of the variable included in a second region that does not share a common region with a first region including the value of the variable related to the constraint condition from a value of the first region; and
finding a solution candidate again after the value of the variable is changed.

7. A non-transitory recording medium storing a program for causing a computer to:
find a solution while finding a solution candidate for an optimization problem with a constraint condition including a variable;
in a case where the constraint condition is not satisfied for the found solution candidate, change a value of the variable related to the constraint condition stricter than a predetermined constraint condition to a possible value of a random variable or change the value of the variable related to the constraint condition to any one of possible values of the variable included in a second region that does not share a common region with a first region including the value of the variable related to the constraint condition from a value of the first region; and
find a solution candidate again after the value of the variable is changed.
